(19) United States
(12) Patent Application Publication
(10) Pub. No.: US 2026/0277615 A1
(43) Pub. Date: Sep. 17, 2026

(54) LIMITED OUT-OF-ORDER EXECUTION FOR MATRIX INSTRUCTIONS

(71) Applicant: QUALCOMM Incorporated, San Diego, CA (US)

(72) Inventors: Luca MARONCELLI, Austin, TX (US); Yiran HUANG, Cambridge (GB); Sneha Rao GADAMBUR RAVI, Sunnyvale, CA (US)

(21) Appl. No.: 19/079,163

(22) Filed: Mar. 13, 2025

(51) Int. Cl. G06F 9/38; G06F 9/30

(52) U.S. Cl. CPC G06F 9/3856; G06F 9/30036

(57) ABSTRACT

Certain aspects of the present disclosure provide a method for processing certain instructions out of order. The method generally includes obtaining a sequence of instructions, allowing re-ordering of a subset of first instructions in the sequence subject to at least one constraint, enforcing program order for at least a second instruction in the sequence that occurs before after the subset of first instructions, and executing the sequence of instructions in accordance with the re-ordering and the enforcement.

### BACKGROUND

### Field of the Disclosure

Aspects of the present disclosure relate to techniques for processing certain instructions out of order.

### Description of Related Art

A central processing unit (CPU) is a primary component of a computer that performs most of processing. The CPU is often referred to as a brain of the computer because the CPU handles execution of instructions from programs, processes data, and controls other parts of the computer.

CPUs come in various designs and architectures, with different numbers of processing cores, clock speeds, and other features, which all affect performance. In some cases, processors (such as CPUs) may process instructions out of order (OoO).

An out-of-order (OoO) processor generally refers to a type of CPU architecture that improves performance by executing instructions not strictly in the order they appear in the program. Rather, an OoO processor dynamically schedules instructions to be executed in “data order” based on the availability of input data and execution resources, rather than their original order in the program code.

With OoO processing, instructions are fetched from memory in the order they appear in the program. After fetching, instructions are decoded to determine what operations need to be performed. Decoded instructions are placed into an instruction queue. This queue holds instructions until they are ready to be executed.

An OoO processor checks the instructions in the queue to determine if they have any dependencies (e.g., an instruction that requires the result of a previous instruction). If an instruction has all the data it needs and the necessary execution unit is available, it can be executed immediately, even if earlier instructions are still waiting for their dependencies.

With OoO processing, instructions are sent to execution units as soon as they are ready (e.g., they have the data they need and processing resources are available), rather than waiting for earlier (in programs order) instructions to finish. As a result, OoO processing may help to make efficient use of CPU resources by avoiding stalling execution of a later instruction because an earlier instruction is waiting for data.

### SUMMARY

One aspect provides a method. The method includes obtaining a sequence of instructions; allowing re-ordering of a subset of first instructions in the sequence subject to at least one constraint; enforcing program order for at least a second instruction in the sequence that occurs before after the subset of first instructions; and executing the sequence of instructions in accordance with the re-ordering and the enforcement.

Other aspects provide: an apparatus operable, configured, or otherwise adapted to perform the aforementioned method as well as those described elsewhere herein; a non-transitory, computer-readable media comprising instructions that, when executed by one or more processors of an apparatus, cause the apparatus to perform the aforementioned method as well as those described elsewhere herein; a computer program product embodied on a computer-readable storage medium comprising code for performing the aforementioned method as well as those described elsewhere herein; and an apparatus comprising means for performing the aforementioned method as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example system-on-chip (SoC), in accordance with certain aspects of the present disclosure.

FIG. 2 depicts example communication between processing cores and a matrix accelerator engine, in accordance with certain aspects of the present disclosure.

FIG. 3 depicts an example block diagram of a matrix accelerator engine, in accordance with certain aspects of the present disclosure.

FIG. 4 depicts an example dispatch buffer (DSB), in accordance with certain aspects of the present disclosure.

FIG. 5 depicts an example dispatch scheme, in accordance with certain aspects of the present disclosure.

FIG. 6 depicts an example sequence of instructions that may be processed in accordance with certain aspects of the present disclosure.

FIG. 7 depicts another example sequence of instructions that may be processed in accordance with certain aspects of the present disclosure.

FIGS. 8A-8E depict an example of managing dependencies for an example sequence of instructions processed in accordance with certain aspects of the present disclosure.

FIG. 9 depicts an example method, in accordance with certain aspects of the present disclosure.

FIG. 10 depicts an example device, in accordance with certain aspects of the present disclosure.

### DETAILED DESCRIPTION

Aspects of the present disclosure relate to techniques for processing certain instructions out of order. The techniques proposed herein may enable limited out-of-order processing for a sequence of instructions that includes one or more instructions that might otherwise prohibit out-of-order processing.

In some cases, a system on a chip (SoC) may include circuitry that is optimized for certain instructions in order to improve performance. For example, a scalable matrix extension (SME) accelerator engine may be optimized to execute matrix related instructions. SME generally refers to an architecture extension that may be designed to improve the performance of a processor executing matrix operations. Improving the performance of executing matrix operations may be particularly beneficial for artificial intelligence (AI) and Machine Learning (ML) workloads, by adding specialized instructions for efficient matrix calculations on CPUs. SME may be based on a Scalable Vector Extension (SVE) feature set.

As noted above, with out-of-order (OoO) processing, instructions are sent to execution units as soon as they are ready (e.g., they have the data they need and processing resources are available), rather than waiting for earlier (in programs order) instructions to finish. As a result, OoO processing may help to make efficient use of CPU resources by avoiding stalling execution of a later instruction because an earlier instruction is waiting for data.

Certain sequences of instructions may present challenges to OoO operation for certain types of processing elements, such as an SME accelerator engine. For example, SME may define matrix multiply (involving outer products) instructions that read and write a matrix register, referred to as ZA (e.g., a large 2-dimensional array register). Because certain instructions that update ZA perform some form of read-multiply-accumulate, these instructions tend to have a true dependency, and a regular scheduler cannot execute them out-of-order. Lack of out-of-order execution may result in significant latencies and stalls due to memory misses, which may significantly degrade performance.

Aspects of the present disclosure, propose mechanisms that may allow for limited out-of-order execution in instruction sequences that might otherwise prohibit out-of-order processing. For example, multiply and accumulate (MAC) type operations may be allowed to execute OoO as long as it is mathematically correct for them to do so (e.g., because addition is a commutative operation). Certain instructions that cannot be reordered, like the ones that move data to and from ZA (e.g., that consume data generated by the instructions executed OoO) may be treated as barriers. As will be described in greater detail below, a mechanism using counters may help manage dependencies and allow limited OoO processing in an instruction sequence that includes barrier instructions that cannot be reordered.

By allowing limited OoO execution, aspects of the present disclosure may help reduce latencies and stalls, which may significantly improve performance.

### Example System-On-Chip (SoC)

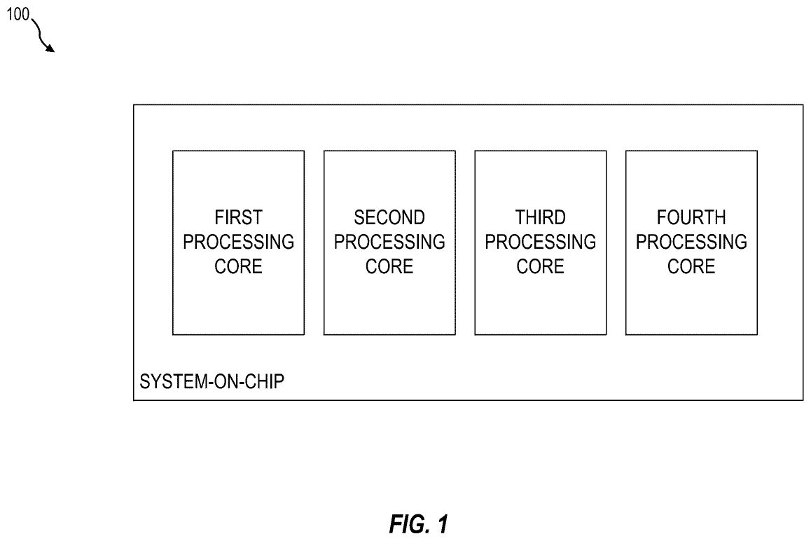

FIG. 1 depicts an example system-on-chip (SoC) 100 with multiple processing cores (e.g., on which artificial intelligence workloads may be processed).

The multiple processing cores may include a first processing core, a second processing core, a third processing core, and a fourth processing core. The first processing core, the second processing core, the third processing core, and the fourth processing core may include at least efficiency cores and performance cores.

The SoC 100 may further include a graphics processing unit (GPU) and a neural processing unit (NPU), amongst other processing units and components on which various compute workloads may be processed (e.g., tensor processing units, application-specific integrated circuits (ASICs), digital signal processors (DSPs), and the like).

The efficiency cores and the performance cores may be processing units implementing a same processing architecture (e.g., processing units implementing advanced reduced instruction set computer (RISC) machines (ARM) or RISC-V architectures). The efficiency cores may have a lower performance (e.g., as measured by a number of operations per second that the efficiency cores can perform) than the performance cores, but may use less power than the performance cores in executing a workload.

The GPU may be a processing unit which is configured to perform large mathematical operations (e.g., matrix, vector, tensor, etc. operations) in parallel.

The NPU is a circuit configured for implementing control and arithmetic logic for executing machine learning algorithms, such as algorithms for processing artificial neural networks (ANNs), deep neural networks (DNNs), random forests (RFs), and the like. The NPU may be referred to as a neural signal processor (NSP), a tensor processing unit (TPU), a neural network processor (NNP), an intelligence processing unit (IPU), a vision processing unit (VPU), or a graph processing unit.

The NPU may be configured to accelerate performance of common machine learning tasks, such as image classification, machine translation, object detection, and various other predictive artificial intelligence models. In some examples, a plurality of NPUs may be instantiated on a single chip while in other examples such NPUs may be part of a dedicated neural-network accelerator.

The NPU may be optimized for training or inference, or in some cases configured to balance performance between both. For the NPU that is capable of performing both training and inference, two tasks may still be performed independently.

The NPU designed to accelerate training may be configured to accelerate an optimization of new artificial intelligence models, which is a highly compute-intensive operation that involves inputting an existing dataset (often labeled or tagged), iterating over a dataset, and then adjusting artificial intelligence model parameters, such as weights and biases, in order to improve artificial intelligence model performance. Generally, optimizing based on a wrong prediction involves propagating back through layers of an artificial intelligence model and determining gradients to reduce a prediction error.

The NPU designed to accelerate inference may be configured to operate on complete artificial intelligence models. The NPU may thus be configured to input a new piece of data and rapidly process this new piece through an already trained artificial intelligence model to generate an artificial intelligence model output (e.g., an inference).

Each of the processing units on the SoC 100 (e.g., the efficiency cores, the performance cores, the GPU, the NPU, and/or other processing units) may have different performance characteristics. The performance characteristics may include a power slope, a leakage power, a dynamic clock and voltage scaling points (e.g., points at which processing core clock speed and voltage draw scales upward or downward), instructions-per-clock cycle (IPC) performance levels, and the like.

The workloads executing on the SoC 100 may be defined by various characteristics which may influence how these workloads, or portions thereof, are scheduled for execution on various processing units of the SoC 100. For example, the workloads may be characterized by a number of stages (e.g., layers) in an artificial intelligence model executing on the SoC 100, a length of an input into the artificial intelligence model, data types associated with each stage or layer of the artificial intelligence model.

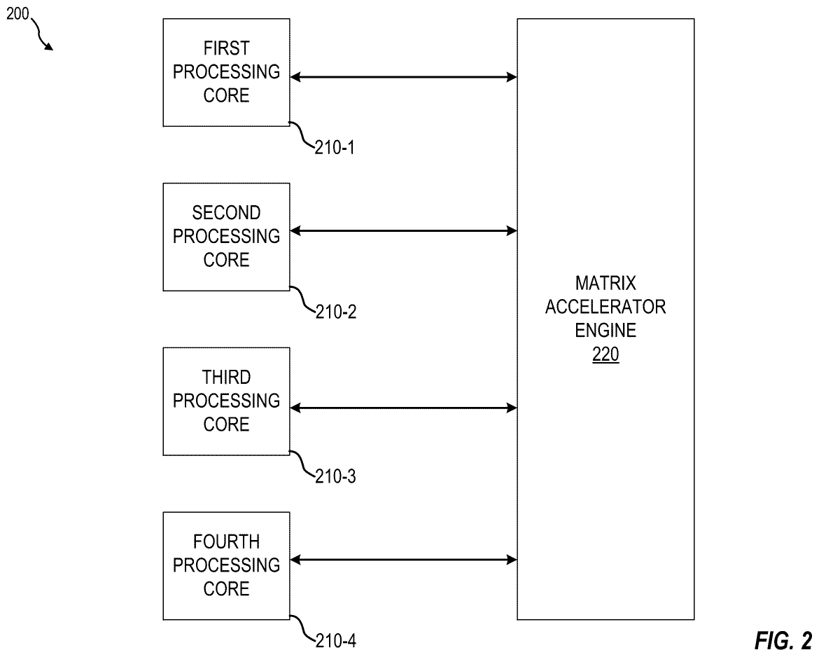

Diagram 200 of FIG. 2 depicts example communication between processing cores (210-1, 210-2, 210-3, and 210-4) and a matrix accelerator engine (e.g., an SME accelerator engine) 220, in accordance with certain aspects of the present disclosure. The SME accelerator engine 220 may be optimized for certain workloads (e.g., AI/ML workloads that involve matrix operations).

Components of the SME accelerator engine 220 may be configured to receive a sequence of instructions from one or more of the processing cores and perform the limited out-of-order execution proposed herein. In some cases, the processing cores may send instruction sequences to the SME accelerator engine 220 via a packet.

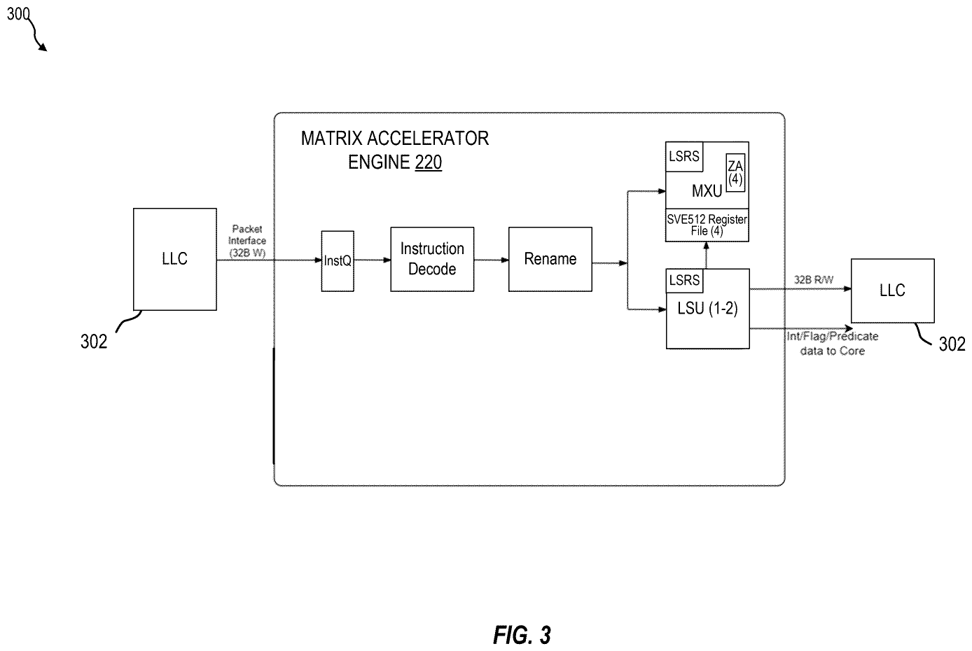

Diagram 300 of FIG. 3 shows the general flow for processing such packets. As illustrated, packets may come from the processing cores via a last level cache (302). Instructions may be stored an in instruction queue (InstQ) before being decoded (and renamed) before execution in one or more execution units. As illustrated, the execution units may include a multiplication execution unit (MXU) and a load store unit (LSU). The MXU may be optimized to perform matrix multiplication operations. The LSU may be optimized to efficiently load data need for such operations and store the results back to the LLC (e.g., for access by the processing core(s) that dispatched the packet).

In some cases, the SME accelerator engine 220 may run on a separate phase locked loop (PLL) with a slower (e.g., 100-200 MHz) clock than a core clock. The clock for the engine may be controlled via a dynamic voltage and frequency scaling (DVFS) finite state machine (FSM). As a result, incoming/outgoing interfaces to the engine may go through an asynchronous interface. These interfaces may include the instruction packet interface for instruction packets from the LLC, a load store interface (e.g., between the LSU and the LLC) an instruction completion interface, and a special purpose register (SPR) interface.

In some cases, an instruction packet arriving from a core may include a header and a variable number of instructions as each instruction can have a variable size payload depending on its type. For example, in some cases, a packet may have 3-6 instructions, which may be packed into a 64-byte packet.

The MXU in SME accelerator engine 220 may be optimized for certain matrix operations. For example, a simple implementation of a matrix multiply operation may have a poor load to multiply ratio (e.g., 2 reads/loads are done for each multiply performed). To improve this, the SME accelerator engine 220 may implement an outer product multiplication performed over the columns and rows of the input matrices, with the results accumulating into the output matrix.

In the MXU, micro operations (uOPs) may be divided into different types. These types may include move type SME operations (SME-MOV uOPS) that move data to a matrix register ZA (e.g., tile to vector, and vector to tile MOV/A operations), non-move type SME (SME-DP uOPS) operations (e.g., addition, subtraction, and outer products and accumulate mopa operations), and scalar vector extension type (SVE uOPS) operations.

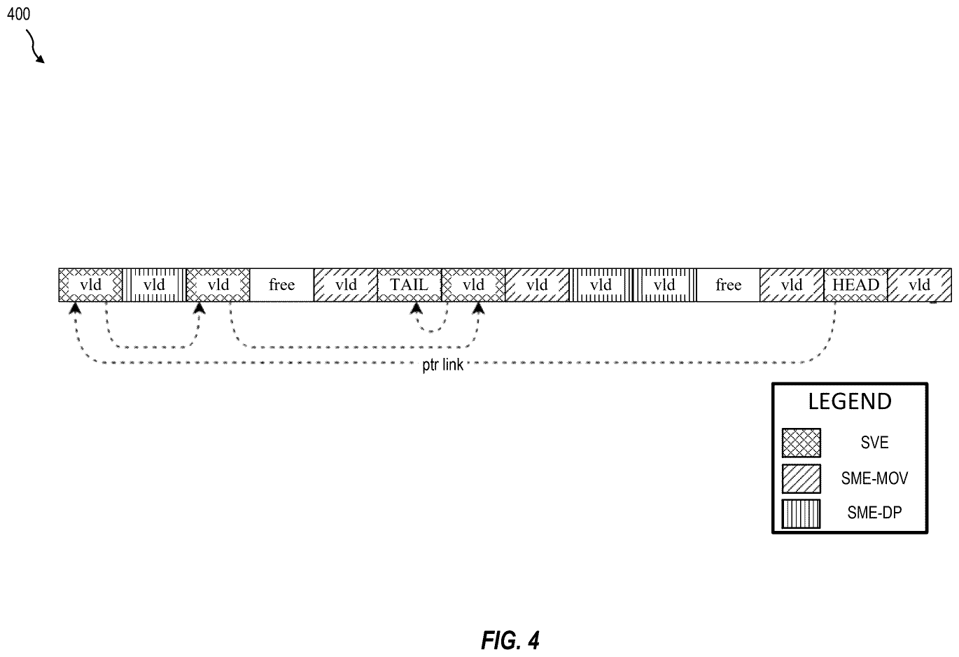

In some cases, instructions may be stored in a dispatch buffer (DSB) prior to execution. As illustrated in diagram 400 of FIG. 4, in some cases, DSB storage may be shared by different uOP types. In such cases, uOPs may be kept separate by implementing three linked lists, one per uOP type. Using separate linked lists, ordering may be preserved between uOPs of the same type, but not between uOPS of different types.

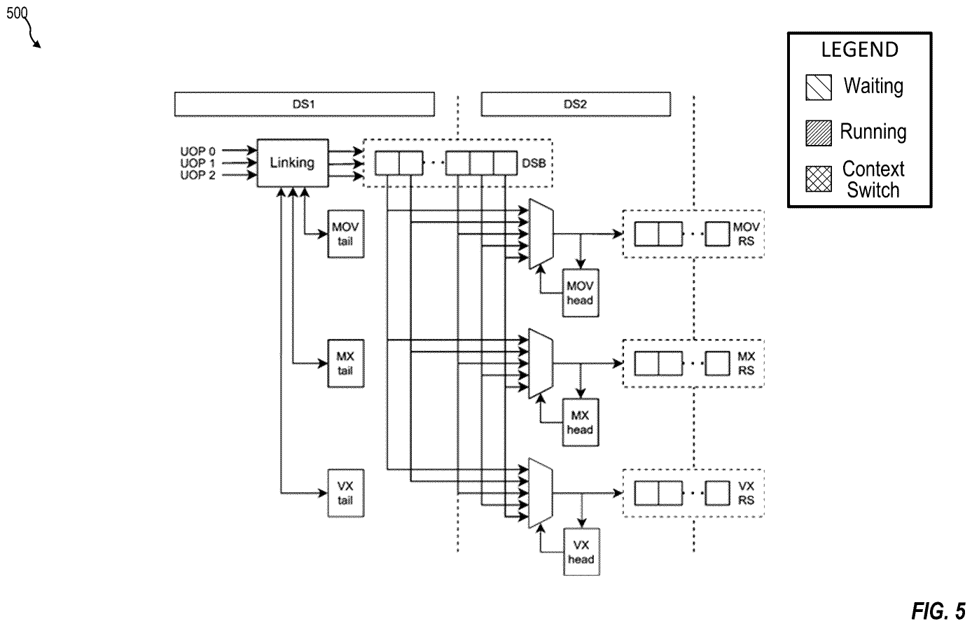

Diagram 500 of FIG. 5 illustrates how the DSB may be part of a two-level dispatch scheme. Compared to a single stage dispatch the two level scheme shown in FIG. 5 may help maintain the same number of instructions in flight (required by the LSU), while reducing the MXU reservation station (RS) sizes. This approach may provide scheduling flexibility and result in reduced power consumption.

As illustrated in FIG. 5, the linked list of each uOPS type may dispatch to its own reservation station: SME-MOV uOPs dispatch into the MOV-RS, SME-DP uOPs dispatch into the MX-RS, and SVE uOPs dispatch into the VX-RS.

The first level of the dispatch scheme (DS1) may be between the rename and retirement unit (REU) and the MXU. At DS1, rename some number (e.g., up to three) uOPs per cycle may be allocated into the DSB. In some cases, the DSB may be banked and each bank may be freelisted. Each bank may allocate up to one uOP per cycle. The number of uOPs dispatched per cycle may be limited by the number of DSB banks with free entries. Ordering between uOPs may be maintained using singly linked lists. Each uOP in the DSB may hold a pointer to the next (younger) uOP in the list.

As illustrated, at the second level (DS2), there may be one reservation station per uOP type (and per linked list). If the reservation station can accept the uOP, the head of the linked list may be removed and the dequeued from the DSB and the uOP may be sent to the appropriate reservation station.

### Example Limited Out-Of-Order Execution for SME Instructions

In general, SME uOPs executed in the SME accelerator engine either read or write the matrix register (ZA) accumulator. The ZA accumulator may not be renamed like other (Z) registers. As a result, it may be important to enforce correct ordering between SME uOPs that read or produce the same ZA tag. In this context, a tag may refer to assigning a tag to a memory location, which can be associated with pointers that reference that memory location.

Aspects of the present disclosure, however, provide mechanisms that may allow for limited out-of-order execution for SME instructions. The mechanisms may take advantage of the fact that, although many SME uOPs must be executed in program order, some relaxations are permissible in certain scenarios.

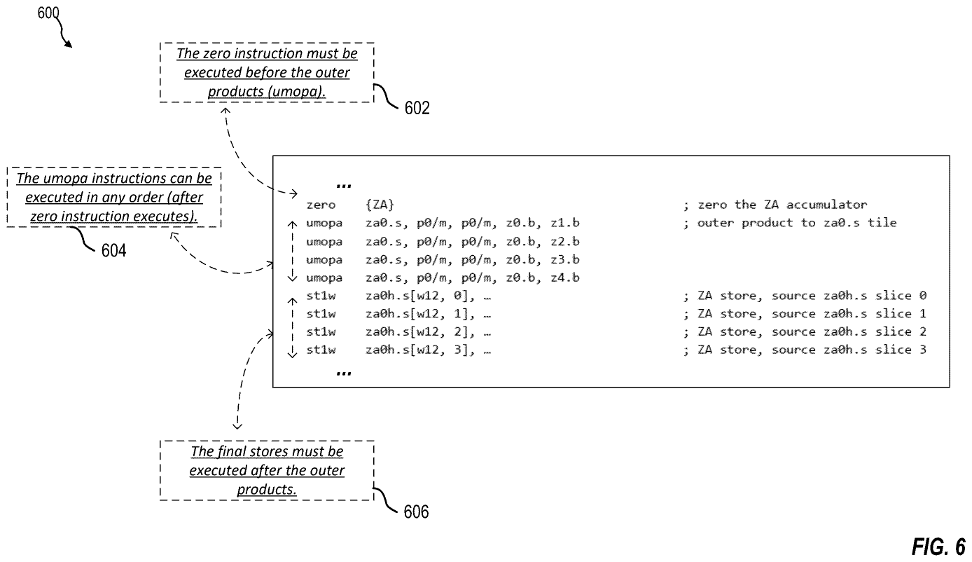

One such scenario is depicted in the example instruction sequence 600 shown in code form in FIG. 6. The illustrated sequence includes a zero operation that zeros the ZA accumulator, followed by four outer product operations (umopas-unsigned integer sum of outer products and accumulate) that produce results in the ZA accumulator, and followed by stores (st1w-contiguous store of words from 32-bit element ZA tile slice).

As noted at 602, the zero instruction needs to be executed before the outer products (umopa operations). After execution of the zero instruction, however, the outer products may be executed in any order (as indicated at 604).

This flexibility for limited out-of-order execution may be a consequence of integer accumulation being a commutative operation. In other words, reordering is permissible because the order in which the accumulations are performed does not affect the final result as long as all accumulations are executed before consuming the result.

As noted at 606, the final stores may need to be executed after the outer products are executed. However, the final stores, if storing to different addresses, may be reordered with respect to one another.

In general, there are various groups of SME instructions that can be reordered with respect to one another. For example, a first group that can be reordered may include integer ZA accumulation and subtraction operations (e.g., addha, addva, smopa, smops, sumopa, sumops, umopa, umops, usmopa, and usmops). This is because such operations are ZA producers and can be reordered because the operations are commutative.

OoO execution for this group of instructions may be particularly useful as they can depend on different Z sources and will stall if their sources are not ready. Thus, OoO execution of this group of operations may result in better resource utilization.

A second group for which reordering could be allowed may include ZA to Z move operations, such as mov (tile to vector) and mova (tile to vector) operations. Such instructions may be reordered because they are ZA consumers and do not pose a hazard to one another. OoO execution for these instructions, however, may have limited benefits as they have the same source and dependency (on ZA).

For other uOPs, that are not in either of the first or second groups, strict ordering may need to be enforced, such that these cannot be bypassed and cannot bypass other uOPs.

According to certain aspects of the present disclosure, a set of counters may be used to handle dependencies between SME uOPs that read or write the same ZA tag.

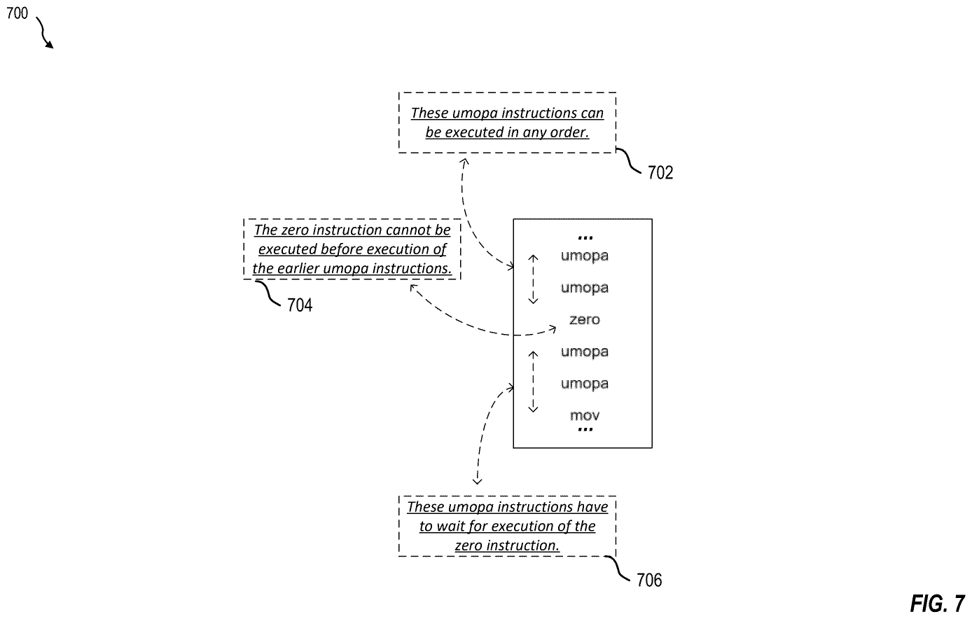

The use of such counters may be understood with reference to the example instruction sequence 700 shown in FIG. 7. The illustrated sequence includes two outer product operations, followed by a zero operation, two more outer product operations, and finally a move operation (mov).

As noted at 702, the first two outer products may be executed in any order, but the zero instruction cannot be executed before the first two outer products are executed (as indicated at 704). Also, the final two outer products have to wait until the zero operation is executed before they are executed.

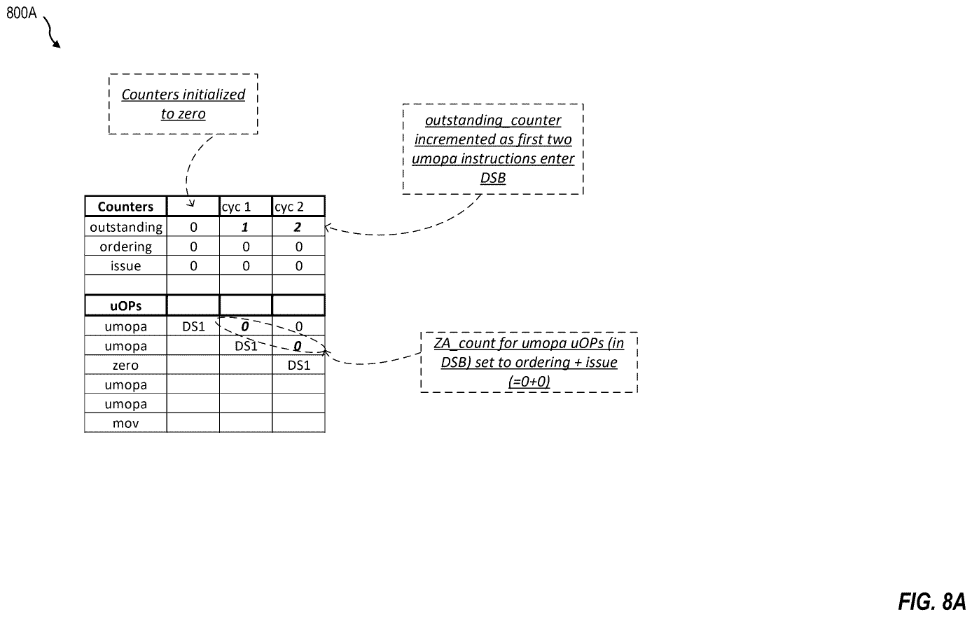

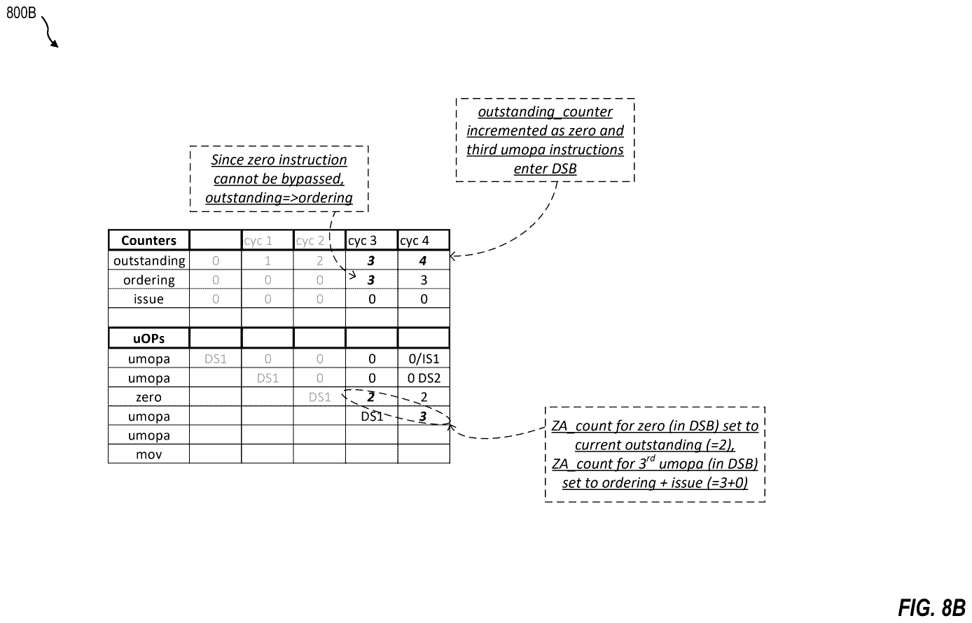

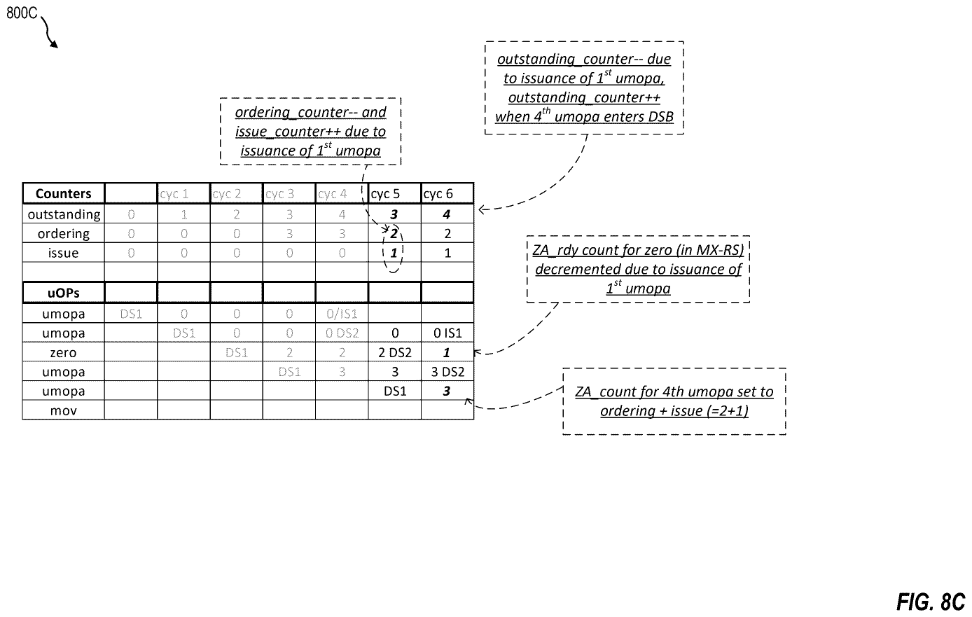

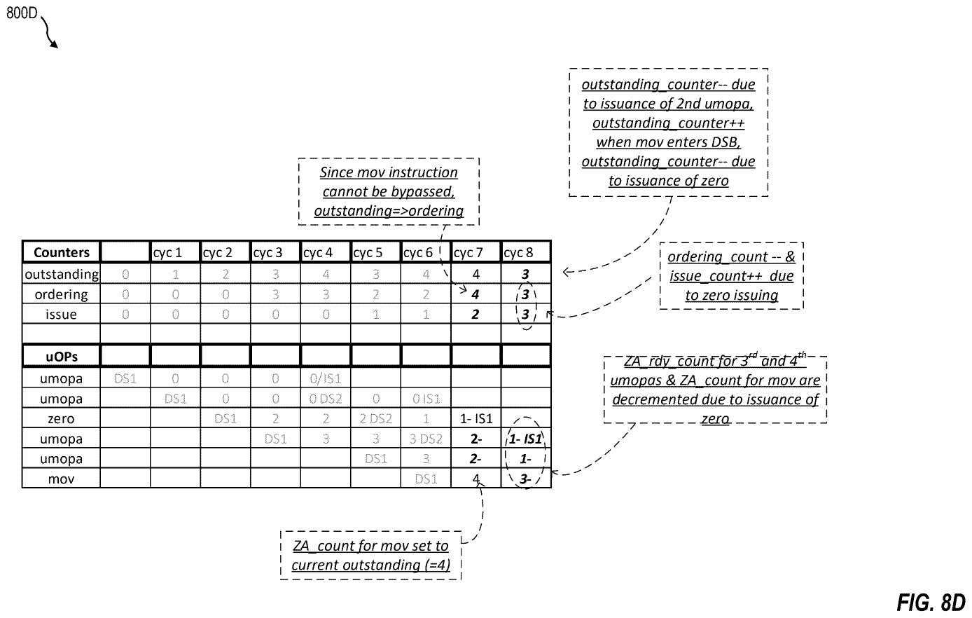

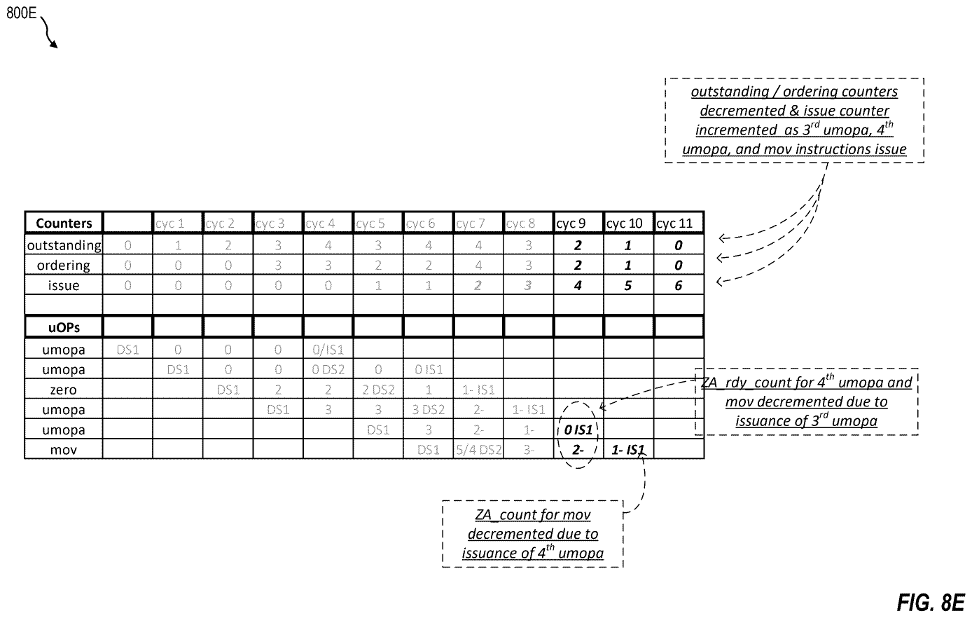

As illustrated in diagram 800A of FIG. 8A, the following counters may be maintained per ZA tag: an outstanding count, an ordering count, and an issue count.

The outstanding count generally tracks the number of SME uOPs in flight (e.g., in the DSB or any of the RS). This counter may be incremented in DS1, when an SME uOP is dispatched to the DSB and may be decremented (e.g., in an issue cycle IS1) when an SME uOP is issued.

The ordering count generally tracks the number of SME uOPs in flight that cannot be bypassed. This counter may be set in DS1 by SME uOPs that require ordering be enforced (e.g., uOPs that cannot be bypassed). This counter may be decremented (in IS1) by any SME uOP that issues.

The issue count generally tracks the number of SME uOPs issued. This counter may be incremented (in IS1) by any SME uOP. In some cases, this counter may not be reset or decremented. Rather, when the counter saturates, it may simply wrap around back to 0.

In addition to the above counters, each uOP in the DSB and RSs may store a counter referred to as a ZA-ready counter (ZA-count in DSB, ZA-rdy-count in RS). This counter may be treated as a source-ready counter and gets decremented as other SME uOPs issue. A uOP ZA dependency may be considered resolved when its ZA count reaches zero.

A scheme utilizing these counters may works as follows. In the DS1 stage of dispatch, for each SME uOP, may compute the following sum:

current issue count+current ordering count,

may be computed and the result of the operation may be stored in the ZA-count field in the DSB. The outstanding count may also be incremented for their ZA tag.

If the uOP requires ordering (e.g., cannot bypass other uOPs or cannot be bypassed by other uOPs) the ordering count may be set to the same value as the outstanding count.

In the DS2 stage, for each SME uOP, the ZA ready count may be computed by calculating the following difference:

ZA Count−Issue Count,

and storing this result in the ZA-rdy-count field in the RS. If an SME uOP is in DS2 while another SME uOP for the same ZA tag is in IS1, the uOP in DS2 may set a ZA decrement field in the RS entry.

In IS1, SME uOPs that issue may set a ZA count decrement flag in the MOV-RS and MOP-RS, along with their ZA tag.

In the MOV-RS and MOP-RS, uOPs may check whether their ZA tag matches the operation that was issued in the cycle before. On a match, the ZA-rdy-count may be decremented. ZA dependencies for a uOP may be considered resolved if the ZA-rdy-count is zero or if the ZA-rdy-count is one but being decremented in the current cycle. This approach may give ZA dependencies a single cycle release.

FIGS. 8A-8E how the counters described above are used and handled for the example instruction sequence shown in FIG. 7. In these figures, the count within each box represents the counter stored by each uOP in flight: ZA-count for uOPs in the DSB, ZA-rdy-count for uOPs in the RS. Further, a ‘−’ sign following the counter (e.g. “1−”) generally indicates that the counter must be decremented as a result of a uOP being issued in the previous cycle. A state/value of 1− may be treated as zero by the RS entry.

Referring first to diagram 800A of FIG. 8A, the counters are initialized to zero. As indicated, the outstanding_count is incremented each cycle (cyc1 and cyc2) as the first two umopa instructions enter the DSB. As illustrated, the ZA-count for these first two umopa instructions may both be set to zero (since ordering_count=0 and issue_count=0 for these first two cycles).

Referring to diagram 800B of FIG. 8B, the zero instruction enters the DSB at cycle 3, the outstanding_count is incremented. As noted, since the zero instruction cannot be bypassed, the ordering_count is set to the outstanding_count (3). The ZA-count for the zero instruction is set to 2 (the current/previous outstanding_count).

In cycle 4, the third umopa instruction enters the DSB. As a result, the outstanding_count is incremented and the ZA-count for the third umopa is set to 3 (ordering=3, issue=0).

Referring to diagram 800C of FIG. 8C, in cycle 5, the outstanding count and ordering_count are both decremented and the issue_count is incremented due to the issuance of the first umopa in the previous cycle.

The fourth umopa instruction enters the DSB at cycle 6, resulting in the outstanding_count being incremented. The ZA-count for the fourth umopa instruction is set to 3 (the current/previous outstanding_count). Further, the ZA_rdy count for the zero instruction (in MX-RS) is decremented due to previous issuance of the 1st umopa.

Referring to diagram 800D of FIG. 8D, in cycle 7, the mov instruction enters the DSB. Since the mov instruction cannot be bypassed, the outstanding_count is set to the ordering_count. The ZA_count for the move instruction is set to the current/previous outstanding_count. In cycle 7, the outstanding counter is maintained the same (e.g., decremented due to issuance of the second umopa, but this is offset due to the mov instruction entering the DSB).

In cycle 8, the outstanding counter is decremented, due to the issuance of the mov instruction in the previous cycle. As illustrated, the ordering_count is also decremented, while the issue_count is incremented. Further, the ZA_rdy_count for the 3rd and 4th umopas and the ZA_count for the mov are decremented due to the previous issuance of the zero.

Referring to diagram 800E of FIG. 8E, in cycle 9, the issuance of the third umopa instruction results in the outstanding and ordering counts being decremented and the issue count being incremented. Similarly, the ZA_rdy_count for the fourth umopa and mov instructions are also decremented. ZA_rdy_count for the fourth umopa is zero, so the fourth umopa issues.

In cycle 10, the previous issuance of the fourth umopa results in the outstanding and ordering counts being decremented and the issue count being incremented. Similarly, the ZA_rdy_count for the mov instruction is decremented. As a result, the mov instruction issues. Therefore, in cycle 11, the outstanding and ordering issues are again decremented and the issue count is again incremented.

As described herein, by allowing limited OoO execution, aspects of the present disclosure may help reduce latencies and stalls, which may significantly improve performance.

### Example Method

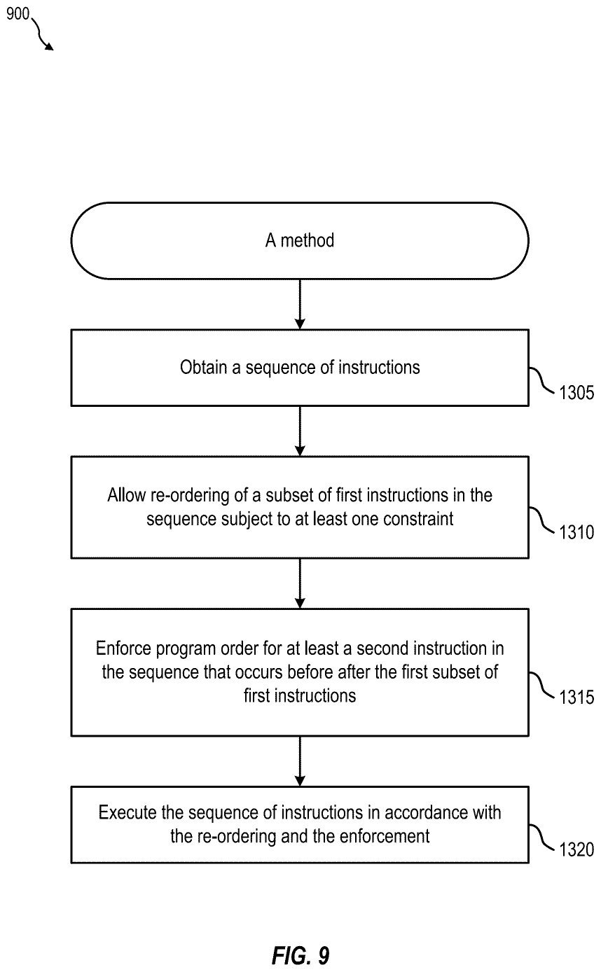

FIG. 9 shows an example of a method 900.

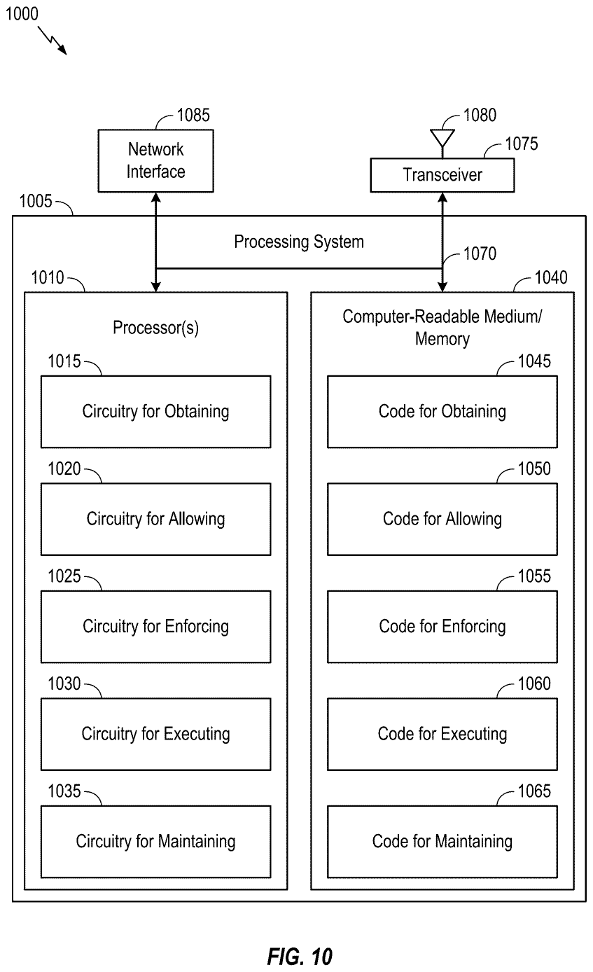

Method 900 begins at step 905 with obtaining a sequence of instructions. In some cases, the operations of this step refer to, or may be performed by, circuitry for obtaining and/or code for obtaining as described with reference to FIG. 10.

Method 900 then proceeds to step 910 with allowing re-ordering of a subset of first instructions in the sequence subject to at least one constraint. In some cases, the operations of this step refer to, or may be performed by, circuitry for allowing and/or code for allowing as described with reference to FIG. 10.

Method 900 then proceeds to step 915 with enforcing program order for at least a second instruction in the sequence that occurs before after the subset of first instructions. In some cases, the operations of this step refer to, or may be performed by, circuitry for enforcing and/or code for enforcing as described with reference to FIG. 10.

Method 900 then proceeds to step 920 with executing the sequence of instructions in accordance with the re-ordering and the enforcement. In some cases, the operations of this step refer to, or may be performed by, circuitry for executing and/or code for executing as described with reference to FIG. 10.

In some aspects, the at least one constraint is that the subset of first instructions correspond to commutative operations.

In some aspects, the subset of first instructions produces results in a matrix register.

In some aspects, the subset of first instructions perform matrix outer product operations and accumulate results in the matrix register.

In some aspects, the second instruction consumes the results in the matrix register produced by the subset of first instructions.

In some aspects, the second instruction zeroes the matrix register.

In some aspects, the method 900 further includes maintaining counters to track dependencies between instructions in the sequence. In some cases, the operations of this step refer to, or may be performed by, circuitry for maintaining and/or code for maintaining as described with reference to FIG. 10.

In some aspects, the counters include: a first counter that tracks a quantity of instructions in-flight, wherein the first counter is incremented when an instruction is dispatched and decremented when an instruction is issued; a second counter that tracks a quantity of instructions that cannot be bypassed, wherein the second counter is set upon dispatch of an instruction for which program order is enforced and decremented when an instruction is issued; and a third counter that tracks a quantity of instructions issued.

In some aspects, the method 900 further includes maintaining a per-instruction counter for each instruction, wherein the per-instruction counter for a given instruction is set to a value based on a sum of current values of the second and third counters when that instruction is dispatched. In some cases, the operations of this step refer to, or may be performed by, circuitry for maintaining and/or code for maintaining as described with reference to FIG. 10.

In some aspects, the second instruction can issue in a cycle when: its per-instruction counter is zero; or its per-instruction counter is one and being decremented in the cycle.

In one aspect, method 900, or any aspect related to it, may be performed by an apparatus, such as device 1000 of FIG. 10, which includes various components operable, configured, or adapted to perform the method 900. Device 1000 is described below in further detail.

Note that FIG. 9 is just one example of a method, and other methods including fewer, additional, or alternative steps are possible consistent with this disclosure.

### Example Device

FIG. 10 depicts aspects of an example device 1000. In some aspects, device 1000 is a wireless node.

The device 1000 includes a processing system 1005 coupled to the transceiver 1075 (e.g., a transmitter and/or a receiver) and/or a network interface 1085. The transceiver 1075 is configured to transmit and receive signals for the device 1000 via the antenna 1080, such as the various signals as described herein. The network interface 1085 is configured to obtain and send signals for the device 1000 via communication link(s), such as a backhaul link, midhaul link, and/or fronthaul link. The processing system 1005 may be configured to perform processing functions for the device 1000, including processing signals received and/or to be transmitted by the device 1000.

The processing system 1005 includes one or more processors 1010. In various aspects, one or more processors 1010 may be representative of one or more of receive processors, transmit processors, TX MIMO processors, and/or other controllers/processors. The one or more processors 1010 are coupled to a computer-readable medium/memory 1040 via a bus 1070. In certain aspects, the computer-readable medium/memory 1040 is configured to store instructions (e.g., computer-executable code) that when executed by the one or more processors 1010, cause the one or more processors 1010 to perform the method 900 described with respect to FIG. 9, or any aspect related to it. Note that reference to a processor of device 1000 performing a function may include one or more processors 1010 of device 1000 performing that function.

In the depicted example, the computer-readable medium/memory 1040 stores code (e.g., executable instructions), such as code for obtaining 1045, code for allowing 1050, code for enforcing 1055, code for executing 1060, and code for maintaining 1065. Processing of the code for obtaining 1045, code for allowing 1050, code for enforcing 1055, code for executing 1060, and code for maintaining 1065 may cause the device 1000 to perform the method 900 described with respect to FIG. 9, or any aspect related to it.

The one or more processors 1010 include circuitry configured to implement (e.g., execute) the code stored in the computer-readable medium/memory 1040, including circuitry such as circuitry for obtaining 1015, circuitry for allowing 1020, circuitry for enforcing 1025, circuitry for executing 1030, and circuitry for maintaining 1035. Processing with circuitry for obtaining 1015, circuitry for allowing 1020, circuitry for enforcing 1025, circuitry for executing 1030, and circuitry for maintaining 1035 may cause the device 1000 to perform the method 900 described with respect to FIG. 9, or any aspect related to it.

Various components of the device 1000 may provide means for performing the method 900 described with respect to FIG. 9, or any aspect related to it. Means for transmitting, sending or outputting for transmission may include the transceiver 1075 and the antenna 1080 of the device 1000 in FIG. 10. Means for receiving or obtaining may include the transceiver 1075 and the antenna 1080 of the device 1000 in FIG. 10.

### Example Clauses

Implementation examples are described in the following numbered clauses:

Clause 1: A method, comprising: obtaining a sequence of instructions; allowing re-ordering of a subset of first instructions in the sequence subject to at least one constraint; enforcing program order for at least a second instruction in the sequence that occurs before after the subset of first instructions; and executing the sequence of instructions in accordance with the re-ordering and the enforcement.

Clause 2: The method of Clause 1, wherein the at least one constraint is that the subset of first instructions correspond to commutative operations.

Clause 3: The method of Clause 2, wherein the subset of first instructions produces results in a matrix register.

Clause 4: The method of Clause 3, wherein the subset of first instructions perform matrix outer product operations and accumulate results in the matrix register.

Clause 5: The method of Clause 3, wherein the second instruction consumes the results in the matrix register produced by the subset of first instructions.

Clause 6: The method of Clause 3, wherein the second instruction zeroes the matrix register.

Clause 7: The method of any one of Clauses 1-6, further comprising maintaining counters to track dependencies between instructions in the sequence.

Clause 8: The method of Clause 7, wherein the counters include: a first counter that tracks a quantity of instructions in-flight, wherein the first counter is incremented when an instruction is dispatched and decremented when an instruction is issued; a second counter that tracks a quantity of instructions that cannot be bypassed, wherein the second counter is set upon dispatch of an instruction for which program order is enforced and decremented when an instruction is issued; and a third counter that tracks a quantity of instructions issued.

Clause 9: The method of Clause 8, further comprising: maintaining a per-instruction counter for each instruction, wherein the per-instruction counter for a given instruction is set to a value based on a sum of current values of the second and third counters when that instruction is dispatched.

Clause 10: The method of Clause 9, wherein the second instruction can issue in a cycle when: its per-instruction counter is zero; or its per-instruction counter is one and being decremented in the cycle.

Clause 11: An apparatus, comprising: at least one memory comprising executable instructions; and at least one processor configured to execute the executable instructions and cause the apparatus to perform a method in accordance with any combination of Clauses 1-10.

Clause 12: An apparatus, comprising means for performing a method in accordance with any combination of Clauses 1-10.

Clause 13: A non-transitory computer-readable medium comprising executable instructions that, when executed by at least one processor of an apparatus, cause the apparatus to perform a method in accordance with any combination of Clauses 1-10.

Clause 14: A computer program product embodied on a computer-readable storage medium comprising code for performing a method in accordance with any combination of Clauses 1-10.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

Means for obtaining, means for allowing, means for enforcing, means for executing, and means for maintaining may comprise one or more processors, such as one or more of the processors described above with reference to FIG. 10.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method, comprising:
obtaining a sequence of instructions;
allowing re-ordering of a subset of first instructions in the sequence subject to at least one constraint;
enforcing program order for at least a second instruction in the sequence that occurs before after the subset of first instructions; and
executing the sequence of instructions in accordance with the re-ordering and the enforcement.

2. The method of claim 1, wherein the at least one constraint is that the subset of first instructions correspond to commutative operations.

3. The method of claim 2, wherein the subset of first instructions produces results in a matrix register.

4. The method of claim 3, wherein the subset of first instructions perform matrix outer product operations and accumulate results in the matrix register.

5. The method of claim 3, wherein the second instruction consumes the results in the matrix register produced by the subset of first instructions.

6. The method of claim 3, wherein the second instruction zeroes the matrix register.

7. The method of claim 1, further comprising maintaining counters to track dependencies between instructions in the sequence.

8. The method of claim 7, wherein the counters include:
a first counter that tracks a quantity of instructions in-flight, wherein the first counter is incremented when an instruction is dispatched and decremented when an instruction is issued;
a second counter that tracks a quantity of instructions that cannot be bypassed, wherein the second counter is set upon dispatch of an instruction for which program order is enforced and decremented when an instruction is issued; and
a third counter that tracks a quantity of instructions issued.

9. The method of claim 8, further comprising:
maintaining a per-instruction counter for each instruction, wherein the per-instruction counter for a given instruction is set to a value based on a sum of current values of the second and third counters when that instruction is dispatched.

10. The method of claim 9, wherein the second instruction can issue in a cycle when:
its per-instruction counter is zero; or
its per-instruction counter is one and being decremented in the cycle.

11. A processing system, comprising:
at least one memory comprising instructions; and
one or more processors configured to execute the instructions to cause the processing system to:
obtain a sequence of instructions;
allow re-ordering of a subset of first instructions in the sequence subject to at least one constraint;
enforce program order for at least a second instruction in the sequence that occurs before after the subset of first instructions; and
execute the sequence of instructions in accordance with the re-ordering and the enforcement.

12. The processing system of claim 11, wherein the at least one constraint is that the subset of first instructions correspond to commutative operations.

13. The processing system of claim 12, wherein the subset of first instructions produces results in a matrix register.

14. The processing system of claim 13, wherein the subset of first instructions perform matrix outer product operations and accumulate results in the matrix register.

15. The processing system of claim 13, wherein the second instruction consumes the results in the matrix register produced by the subset of first instructions.

16. The processing system of claim 13, wherein the second instruction zeroes the matrix register.

17. The processing system of claim 11, wherein the one or more processors are further configured to maintain counters to track dependencies between instructions in the sequence.

18. The processing system of claim 17, wherein the counters include:
a first counter that tracks a quantity of instructions in-flight, wherein the first counter is incremented when an instruction is dispatched and decremented when an instruction is issued;
a second counter that tracks a quantity of instructions that cannot be bypassed, wherein the second counter is set upon dispatch of an instruction for which program order is enforced and decremented when an instruction is issued; and
a third counter that tracks a quantity of instructions issued.

19. The processing system of claim 18, wherein the one or more processors are further configured to:
maintain a per-instruction counter for each instruction, wherein the per-instruction counter for a given instruction is set to a value based on a sum of current values of the second and third counters when that instruction is dispatched.

20. An apparatus, comprising:
means for obtaining a sequence of instructions;
means for allowing re-ordering of a subset of first instructions in the sequence subject to at least one constraint;
means for enforcing program order for at least a second instruction in the sequence that occurs before after the subset of first instructions; and
means for executing the sequence of instructions in accordance with the re-ordering and the enforcement.
